(19) United States
(12) Patent Application Publication
(10) Pub. No.: US 2016/0090048 A1
(43) Pub. Date: Mar. 31, 2016

(54) MODULAR SYSTEM FOR MOUNTING ACCESSORIES AND RELATED METHODS

(71) Applicants: Robert Crandall, Yorba Linda, CA (US); Scott Cover, Fullerton, CA (US)

(72) Inventors: Robert Crandall, Yorba Linda, CA (US); Scott Cover, Fullerton, CA (US)

(21) Appl. No.: 14/866,520

(22) Filed: Sep. 25, 2015

Related U.S. Application Data
(60) Provisional application No. 62/055,550, filed on Sep. 25, 2014.

(51) Int. Cl. B60R 9/00

(52) U.S. Cl. CPC B60R 9/00

(57) ABSTRACT

A modular system for a vehicle comprises a multi-component support structure which includes a pair of side supports, a pair of base supports, and a horizontal support suspended between the pair of side supports. Each side support comprises a vertical portion, a base portion extending from the vertical portion and coupled to the base support, and a gusset plate interconnecting the vertical portion with the base portion. An attachment is removably coupled to the support structure.

### FIELD OF ART

The field of the invention relates to accessories for vehicles and more particularly to modular systems and methods for mounting accessories onto a vehicle.

### BACKGROUND

Vehicles are often sold without or with minimal options for attaching accessories. For example, pickup trucks may have a rear bed area with tie down locations but are not adequate beyond simple use and fail to fulfill personal requirements held by some pickup truck owners. These needs can vary depending on the occasions, such as for camping, hauling, or traveling.

Various solutions have been created to address the problem of accessory mounting for vehicles, including basic track systems. However, existing solutions have many drawbacks including limits in the number of accessories that can be mounted, or lacking a modular design which enables the vehicle owner to modify the accessory mounting system to achieve a different look or function.

### SUMMARY

Accessory mounting systems, such as modular rack systems having multi-component support structures, disclosed herein may be installed onto vehicles using stake bed pocket attachments and/or a universal rail and clamping attachment. Accessory mounting systems such as a Bed Rail System (BRS) have a modular construction which can be deconstructed and placed into conventional shipping boxes (non-oversized) and quickly re-assembled for installation on a vehicle.

Aspects of the present disclosure include a modular system for mounting accessories to a vehicle. The modular system can comprise a multi-component support structure with an attachment removably coupled to the support structure. The multi-component support structure can comprise a pair of side supports and a pair of base supports coupled together to the vehicle. Each side support can comprise a vertical portion, a base portion extending from the vertical portion, and an optional gusset plate interconnecting the vertical portion with the base portion. The vertical portion and the base portion can form an angle therebetween. Each base support can be coupled to the base portion of the side support.

Opposite ends of a horizontal support can be suspended between the vertical portions.

A clamping attachment can be configured to clamp the structure to the vehicle.

A plurality of stake inserts comprising an anchor portion configured to be received in a stake pocket of the vehicle, a connecting portion configured to engage a surface of the base support or side support, and a mounting plate configured to restrict the depth of the anchor portion in the stake pocket can be included.

The anchor portion can be a long rectangular block having a size substantially equal to or slightly less than a size of the stake pocket.

The rectangular block can have a rubber coating.

The anchor portion can be fixed by a clamping force.

The attachment can have a left side bracket, a right side bracket, and a module coupled between the left side bracket and the right side bracket. The left side bracket and the right side bracket can be coupled to the horizontal support.

The module can be a platform configured to support weight bearing against the platform.

Loops or hooks can extend outwardly from the left and right side brackets to provide securing locations for a securing mechanism to extend over and secure items resting against the platform.

The module can be a light bar pivotably coupled to the left side bracket and the right side bracket.

The attachment can be one or more cross members extending between the base supports and slidably fixed along tracks defined in a surface of the base support.

Track mounts can be provided on opposite ends of the cross members to engage and slide along the tracks of the base supports.

A locking feature can lock the track mount at a desired location.

One or more accessory mounts can be fixed along the cross member. The mount can be a bicycle mount.

The attachment can be a tire mount coupled to a bar support.

The tire mount can comprise a tire support flange coupled to a pair of support hooks by an intermediate extension member, and a locking mechanism to prevent the tire mount from unintended movement or release.

A handle can be coupled to the base support to form a grip for a user to provide access to the vehicle.

A light strip can be coupled directly to the multi-component support structure.

A further aspect of the present disclosure includes a method of manufacturing a modular system for a vehicle. The method can comprise forming a multi-component support structure comprising: providing a pair of side supports, each side support comprising a vertical portion, a base portion extending from the vertical portion, and a gusset plate interconnecting the vertical portion with the base portion, the vertical portion and the base portion forming an angle therebetween, coupling a pair of base supports to the base portions of the side supports, and suspending a horizontal support between the vertical portions and removably coupling an attachment to the support structure.

The attachment can be at least one of a cross member extending between the base supports, a tire mount coupled to one base support, a light strip coupled directly to the support structure, a light bar coupled to the horizontal support, and a platform coupled to the horizontal support.

A still further aspect of the present disclosure includes modular system for mounting on a vehicle, the modular system comprising a multi-component support structure and an attachment removably coupled to the support structure, the support structure having a width and a length and comprising: two side supports, each side support comprising a vertical portion, a lower base portion extending from the vertical portion, and a gusset plate interconnecting the vertical portion with the lower base portion; two base supports respectively removably coupled to the lower base portions; a horizontal support removably attached to the two side supports; and wherein the horizontal support or the two base supports are interchangeable with a second horizontal support or a second set of two base supports to produce a support structure having a different width, a different length, or both a different width and a different length.

The modular system can further comprise an attachment device configured to clamp the support structure to a vehicle.

The modular system can further comprise a plurality of stake inserts, each stake insert can comprise an anchor portion configured to be received in a stake pocket of a vehicle, a connecting portion configured to engage a surface of the base support or side support, and a mounting plate configured to restrict the depth of the anchor portion in a stake pocket.

The modular system wherein the anchor portion can be a long rectangular block having a size substantially equal to or slightly less than a size of a stake pocket.

The modular system wherein both the horizontal support and the second set of two base supports can be interchangeable to produce both a different width and a different length.

The modular system can further comprise a T-slot on a side of at least one of the base supports.

The modular system wherein the attachment can include a left side bracket, a right side bracket, and a module coupled between the left side bracket and the right side bracket.

The modular system wherein the module can be a platform configured to support a surface bearing against the platform.

The modular system wherein loops or hooks can extend outwardly from the left and right side brackets to provide securing locations for a securing mechanism to extend over and secure the surface against the platform.

The modular system wherein the module can be a light bar pivotably coupled to the left side bracket and the right side bracket.

The modular system wherein the attachment can be one or more cross members extending between the two base supports that can be slidably fixed along tracks defined in a surface of each of the two base supports.

The modular system wherein a track mount can be provided on each of two opposite ends of each cross member to engage and slide along the tracks of the base supports.

The modular system wherein a locking feature can be provided with each track mount to lock the track mount at a desired location.

The modular system wherein one or more accessory mounts can be fixed along the cross member.

The modular system wherein the attachment can be a tire mount coupled to a bar support.

The modular system wherein the tire mount can comprise a tire support flange coupled to a pair of support hooks by an intermediate extension member, and a locking mechanism can prevent the tire mount from unintended movement or release.

The modular system wherein a handle can be coupled to one of the base supports and to provide a gripping surface for a user to provide access to a vehicle.

The modular system wherein a light strip can be coupled directly to the multi-component support structure.

The modular system wherein the left side bracket and the right side bracket can be coupled to the horizontal support.

Another aspect of the present disclosure includes a method of manufacturing a modular system for a vehicle. The method can comprise: providing two side supports, each side support comprising a vertical portion, a lower base portion extending from the vertical portion, and a gusset plate interconnecting the vertical portion with the base portion; coupling two base supports to corresponding lower base portions of the two side supports; removably coupling a horizontal support between the two side supports; the two side supports, the two base supports, and the horizontal support forming a multi-component support structure having a length and a width; removable coupling an attachment to the support structure; and providing removable connections at the two side supports for replacing the horizontal support with a second horizontal support, for replacing the two base supports with a second set of two base supports, or to replace both the horizontal support with a second horizontal support and the two base supports with a second set of two base supports.

The method wherein the attachment can be at least one of a cross member extending between the base supports, a tire mount coupled to one base support, a light strip coupled directly to the support structure, a light bar coupled to the horizontal support, and a platform coupled to the horizontal support.

### BRIEF DESCRIPTION OF THE DRAWINGS

These and other features and advantages of the present devices, systems, and methods will become appreciated as the same becomes better understood with reference to the specification, claims and appended drawings wherein:

FIGS. 1A and 1B are perspective views of a modular system, such as a modular rack system, with base supports, vertical supports, and a horizontal support according to an embodiment of the present invention.

FIG. 1C is an exploded perspective view of the modular system of FIGS. 1A and 1B.

FIGS. 2A and 2B are perspective views of an embodiment of a modular system with risers and an attachment extension.

FIG. 3 is a perspective view of an embodiment of a modular system with a detachable rack cross member.

FIG. 4 is a perspective view of an embodiment of a modular system with detachable horizontal supports usable with or as a cover system.

FIG. 5 is a perspective view of an embodiment of a modular system with a detachable handle.

FIGS. 6A and 6B are different perspective views of an embodiment of a modular system with a detachable spare tire mount.

FIG. 7 is a perspective view of an embodiment of a modular system with a light bar or light system.

FIG. 8 shows an exploded view of an exemplary embodiment of a modular system including the modular design that can be separated for ease of shipping and re-assembly and/or for interchanging to produce a support system having a different width, a different length, or both.

FIG. 9 shows a perspective view of an embodiment of a modular system with an integrated light system.

### DETAILED DESCRIPTION

The detailed description set forth below in connection with the appended drawings is intended as a description of the presently preferred embodiments of vehicular modular systems and accessories provided in accordance with aspects of the present devices, systems, and methods, and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

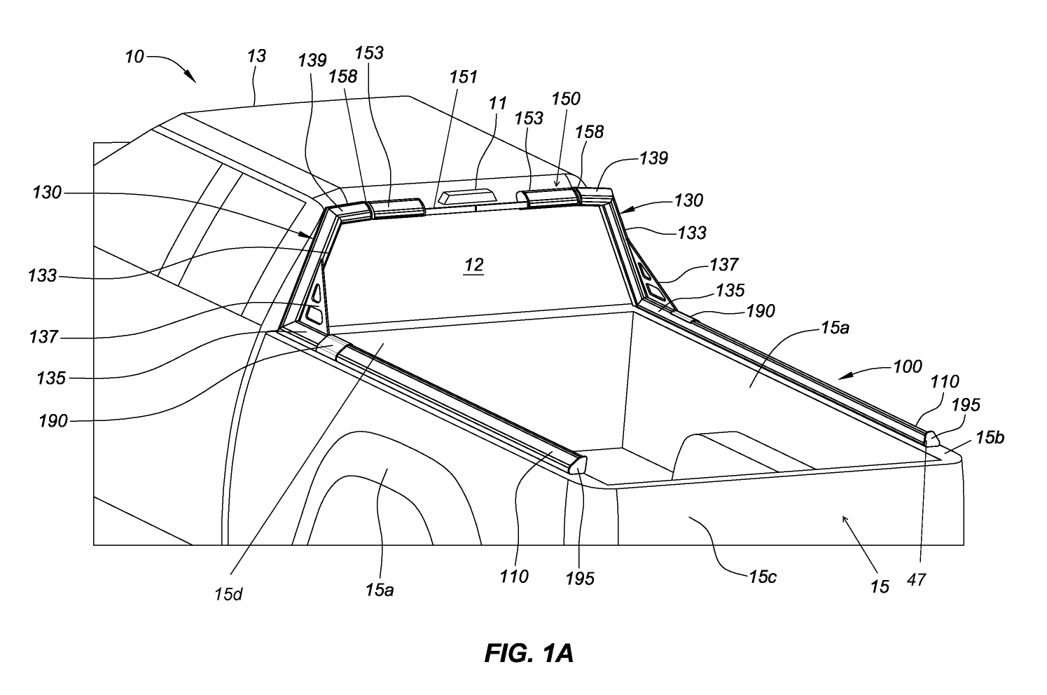

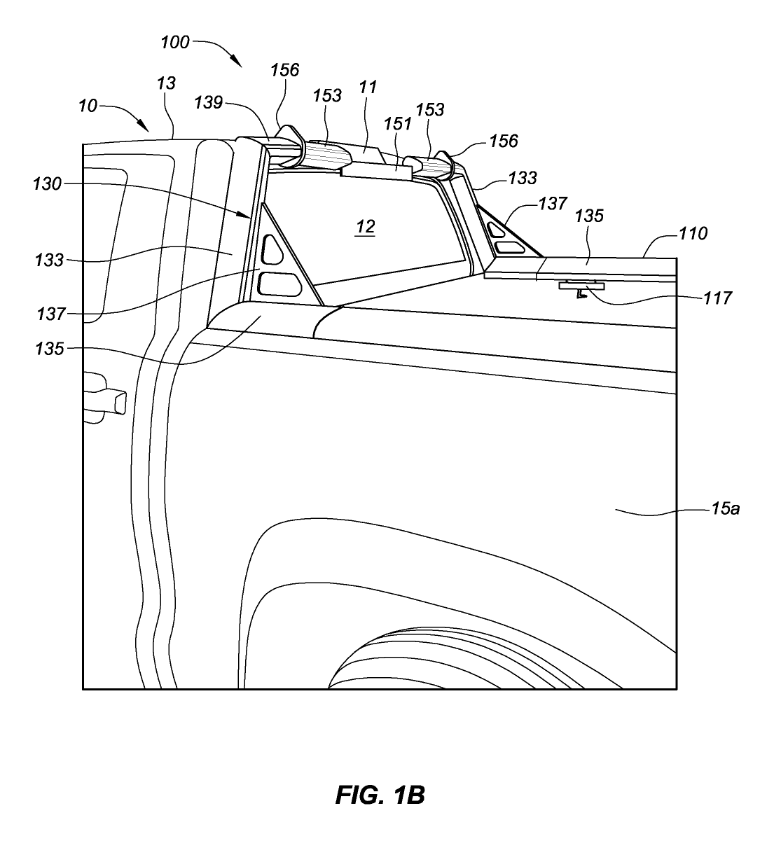

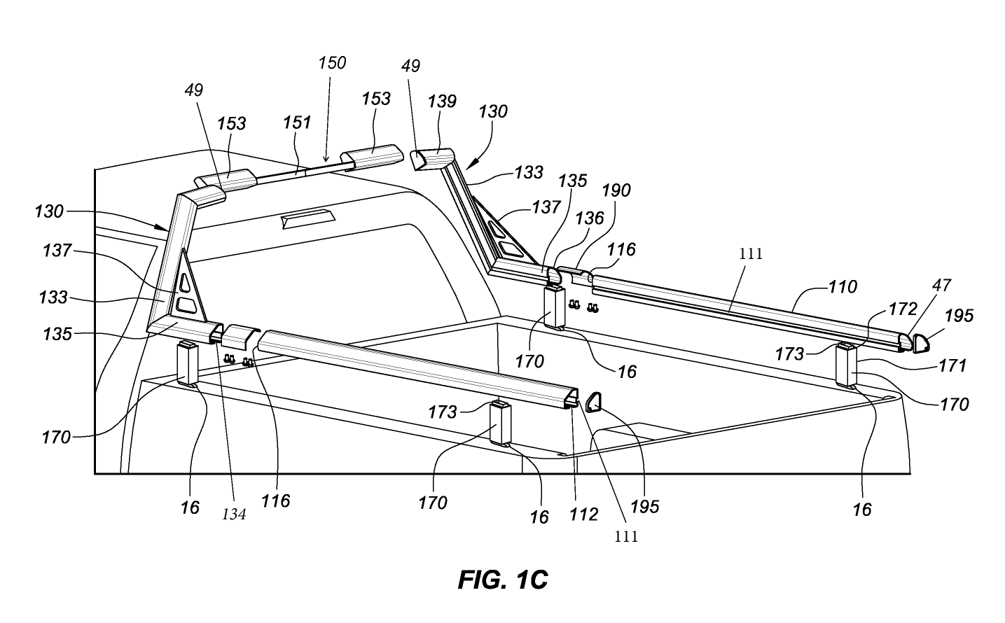

FIGS. 1A and 1B are perspective views of an embodiment of a modular system 100 for mounting on a vehicle 10 provided in accordance with aspects of the present disclosure. The modular system 100 can itself be considered an accessory to the vehicle 10 and is modular as it provides simple add-ons and scaling, as further discussed below. Broadly speaking, the modular system 100 comprises a multi-component support structure having one or more attachments or attachment extensions removably coupled to the support structure. Different parts of the modular system 100 can be swapped out for similar but different sized parts to form different sized support structures for different sized vehicles. Various number of attachments and accessories are usable with the modular system.

As shown, the modular system 100 is assembled on a pickup truck having a cab 13 connected to an open pickup bed 15. In the illustrated embodiment, the modular system 100 includes or comprises the following multi-component support structure: a pair of base supports 110, side supports 130 coupled to the two corresponding base supports 110, and a horizontal support 150 connected to the side supports 130. Each side support 130 and base support 110 can form a generally L-shaped structure with the angle between the two sections of the L-shaped structure being adjustable to permit adaptation and/or compliance to various sized vehicles. The horizontal support 150 connects the two L-shaped structures together to form the modular system 100 of the present disclosure. The base supports 110 can couple or attach to a top edge 15b of the two side walls 15a of the pickup bed 15 and the side supports 130 are attached to the two side walls 15a by virtue of being connected to the base supports 110 to fix the modular system 100 to the pickup bed 15. In other examples, as further discussed below, the side supports 130 can connect directly to the side walls 15a in addition to the base supports 110 being connected to the sidewalls 15a.

Due to the easily adaptable and adjustable nature of the modular system 100 of the present disclosure, the base supports 110 can be adapted to provide attachment means for various other accessories and components and can themselves be swapped out for different sized base supports to fit a different sized vehicle. Starting with the two side supports 130, as shown in FIG. 1C, the modular rack system 100 can be adapted to fit various sized vehicles by attaching different size components to the two side supports 130. For example, by using the two side supports 130 and different lengths for the base supports 110 and different length for the connecting horizontal support 150, the overall dimension of the modular rack system 100 can be adapted to fit different sized pickup bed 15, as further discussed below. Alternatively, one of the other components can form the basis of the modular system 100 and the remaining components can be interchangeable. For example, the horizontal support 150 and the two base supports 110 can form the base of the modular system and the two side supports 130 can be interchangeable to fit different sized vehicles.

With reference again to FIG. 1A, the two base supports 110 can embody extruded extension bars or rails, such as from aluminum, running along a top edge 15b of each side wall 15a of the pickup bed 15. In other embodiments, the base supports 110 can be mounted elsewhere on the vehicle 10, such as along inner and/or outer surfaces of the pickup bed 15, along a front wall 15b of the pickup bed 15 closest to the cab 13, and/or along a tailgate 15c of the pickup bed 15 opposite the front wall 15b. For a vehicle with a roof, such as an SUV, the base supports 110 can be mounted onto the roof of the vehicle. Although the base supports 110 are shown as running substantially parallel to surfaces of the vehicle 10, they can be mounted at a slight angle or along other orientations, as may be implemented and understood by a person of ordinary skill in the art. The shape, length, width, and height of the base supports 110 may also be adjusted to conform to different length pickup beds 15, to different shaped beds, meet stiffness or strength requirements, or accommodate individual user preferences. For example, with reference to FIG. 1C, by selecting different lengths base supports 110 for use with the two side supports 130, the modular rack system 100 can fit different length pickup beds 15. Thus, the width, the length, or both the width and the length of the support structure of the modular system can be adjustable for use with different applications, such as for use with different sized and/or shaped vehicles. For example, the side supports, such as the vertical portions, can be adjusted in height to fit different sized cabs, such as different cab heights.

In an example, the cross-sectional shape of the two base supports 110 has a triangular shape with the base of the cross-section being somewhat rounded and the corners also rounded. The cross-sectional shape of each base support 110 allows it to be mounted directly to the top edge 15b of the truck bed 15, using a clamp or other means as discussed below, or be equipped with other engagement mechanisms to attach to the truck bed 15, such as by incorporating a T-slot for receiving a T-guide located on guide rail stake inserts 170 located on or in a sidewall 15a of the vehicle, as further discussed below. In other examples, the base support 110 may have other cross-sectional shapes, such as elongated oval shape, a polygonal shape, or an irregular shape, with a bottom surface sized and shaped to couple to the top edge 15a of the sidewall 15a. Each base support 100 has two free ends 47, 116 with one to be covered by an end plate and the other to be connected adjacent a side support 130. The base supports 110 can be made of a suitable material such as reinforced plastic or a metal material, such as extruded aluminum.

The modular system 100 can be detachably fixed to the vehicle 10 by using one or more clamping attachment devices 117 (FIG. 1B) to couple the base supports 110 to the vehicle 10. For example, an extension or rod, such as a threaded rod, can extend from the base support to below the top edge 15b and be held from below by an attachment device 117. Alternatively, as shown in FIG. 1C, the base supports 110 may be coupled to the vehicle 10 using one or more stake bed attachment inserts 170 held in stake pockets 16 provided along the top edge 15b of the sidewalls 15a in addition to or instead of using clamping attachment devices 117. Multiple stake inserts 170 may be used, such as two or more, including four or more stake inserts. The stake inserts 170 can be removably installed in the stake pockets 16 and held thereto by heavy duty pins or other fasteners to serve as anchors for the base supports 110. Each stake insert 170 has an anchor portion 171 received and secured in the stake pocket 16, a connecting portion 173 coupled to the base support 110, and a mounting plate 172 connected to the connecting portion 173. In some examples, the mounting plate 172 and the connecting portion 173 are integrally formed and the combination can either fasten to or be integrally formed to the anchor portion 171. When installed, the mounting plate 172 can seat against, adjacent or along the top edge 15b of the sidewall 15a and the connection portion 173 provides a mounting surface or mounting means for a channel or groove formed with each base support 110 to attach there-against. The connection portion 173 can alternatively function as a flange for mating to another flange or plate on the base support 110 and the two secured together using fasteners or the like. Alternatively, the mounting plate 172 is separate from the connecting portion 173 and the two can be mechanically secured to one another, such as using detents, fasteners, press fit, etc.

In FIG. 1C, the anchor portion 171 is a long rectangular block having a cross-section approximate in size to the opening of the stake pocket 16. The choice of length, shape, and material of the block can be selected to resist removal of the stake insert 170 from the pocket 16. For example, the block can be made of a material such as rubber to increase friction between the rubber block and the stake pocket 16. The length of the block and a tight fit between the perimeter of the block and opening of the stake pocket 16 can also impede removal by increasing the distance and limiting the angles at which the stake insert 170 can be removed from the stake pocket 16.

In other examples, the anchor portion 171 can include a clamping mechanism having a catch which extends into the stake pocket 16 and engages an internal mounting feature located inside the stake pocket 16. For example, a bottom end of the anchor portion 171 can include an extended flange or catch, such as a rectangular shaped catch, and can be rotated once inside the stake pocket 16 to engage spaced apart horizontal ledges having a gap therebetween. Because the length of the rectangular catch is greater than the gap between the ledges, a physical barrier is provided to prevent the rectangular catch from coming back out the stake pocket 16 once rotated to engage the ledges. To provide a positive bias to prevent rattling or the rectangular catch from possibly turning loose and escaping from the hold provided by the two spaced apart ledges, fasteners may be provided near or at the mounting plate 172 or between the rectangular catch and the ledges to take up unwanted slack and to provide positive securement or clamping forces. One or more springs may also or alternatively be used to generate the pre-loading to restrict counter-rotation. The mounting plate 172 and the top edge 15b of the sidewall 15a at the top of the stake insert 170 and the rectangular catch clamping against the ledges at a location below the mounting plate 172 will secure the stake insert 170 to the sidewall 15a. To remove the stake insert 170 from the stake pocket 16, the fasteners can be loosened to remove the clamping force. Because the catch at the lower end of the anchor portion 171 has a width less than gap between the ledges, the stake insert 170 can be rotated 90 degrees so that the rectangular catch can pass between the ledges to remove the stake insert 170 from the stake pocket 16. Each of stake inserts 170 may also be fixed to the stake pockets 16 by other conventional means.

In an example, the connecting portion 173 of the stake insert 170 extends from the mounting plate 172 to engage the base support 110 to join the modular system 10 to the vehicle 10. In one example, the connecting portion 173 is a male detent engaging a female detent in the base support 110, such as a T-guide and a T-slot arrangement or a dovetail arrangement. In another example, the base support 110 snaps onto or fastens into the connecting portion 173. As shown in FIG. 1C, the connecting portion 173 can be a protrusion or a guide pin slidably received inside a guide rail 112 of the base support 110 with set screws or other means to prevent the base support 110 from sliding after a desirable position is obtained. Other attachment means can be used to couple the base support 110 to the connecting portion 173.

End caps 195 may be provided to close a rear open end 47 of the base support 110, closest to the tailgate 15c, before or after the base supports 110 are coupled or attached to the vehicle 10. For example, the end caps 195 can close off the guide rails 112 after the connecting portions 173 have engaged the guide rails 112. The end caps 195 can also prevent dust and other build ups from entering the interior of the two base supports 110. As shown, each end cap 195 can frictionally engage the exterior and/or interior of an open end 47 of a respective base support 110 to secure thereto. In some examples, detents, fasteners, such as set screws, or other securement means may be used to more securely attach the end caps 195 to each end of the base support 110. The end caps 195 can be metallic or plastic, machined from billet aluminum, molded from plastic injection molds, or made from other appropriate methods with other materials contemplated.

The front or other open end 116 of the base support 110 (FIG. 1C) can be connected to a respective side support 130 by a coupling, a rail, a flange, a clamp or to one of the stake inserts 170. Each side support 130 can have a lower base portion 135, a vertical portion 133 extending laterally from the lower base portion 135, a gusset plate 137 formed at or near a joint between the vertical portion 133 and the lower base portion 135, and an upper base portion 139. In some examples, the gusset plate 137 can be omitted by improving structural integrity between the vertical 133 and lower base 135 portions through other means and the upper base portion 139 can be omitted by lengthening the horizontal support 150 to connect to the vertical portion 133, as further discussed below.

The lower base portion 135 of each side support 130 can be permanently or detachably fixed to the vehicle 10 using a rail and a clamping attachment 117, a stake insert 170 to couple the side support 130 to the vehicle 10, as discussed above for fixing the base supports 110, and/or rigidly attach the lower base portion 135 to a respective end of a base support 110 and the base support 110 attach to the vehicle 10. As shown in FIG. 1C, the connecting portion 173 of the stake insert 170 can be a protrusion or guide pin slidably received inside a guide rail 134 of the lower base portion 135 with set screws or other means to prevent the side support 130 from sliding after a desirable position is obtained. The lower base portion 135 can also be coupled to the stake inserts 170 directly by fasteners, snap fits, detents, or other attachment means.

The lower base portion 135 can be coupled directly or indirectly to the base support 110 to further strengthen the attachment of the modular system 100 to the vehicle 10 by joining the side support 130 and the base support 110 together. In one example, a free end 136 of the lower base portion 135 is slid into the proximal end 116 of the base support 110 or vice versa to couple the lower base portion 135 to the base support 110 prior to installation on the vehicle 10. The joined lower base portion 135 and base support 110 can be held together by press fit, detents, snap fits, fasteners, or other attachment means. For further flexibility, a coupling can be provided having two open ends for receiving the free end 136 of the lower base portion 135 and the free end 116 of the base support 110. Further, instead of a coupling having two open ends, one or more flange pieces may be used along with screws or fasteners to join the two free ends 116, 136 together. As shown in FIG. 1C, the guide rail 134 of each lower base portion 135 is configure to connect to the connecting portion 173 of the forward stake insert 170 and the free end 116 of the lower base support 110 is connected to the free end 136 of the base support 110, such as by telescope, coupling, flanges, etc., discussed above. A second stake insert 170 holds the base support 110 at or near the opposite free end 47 to provide each side with at least two holding points. Thus, each side of the modular rack system 100 is held by at least two points, joints, or connections to a sidewall 15a of a vehicle 10.

A cover plate 190 can be used to cover or otherwise hide the joint or overlap between the base support 110 and the lower side support 130 from view. The cover plate 190 can snap over the joint ends and held thereto by detents, fasteners, or combinations thereof. In another example, the cover plate 190 is omitted. In some examples, the cover plate 190 can be a coupling member that couples the free ends 116, 136 of the base support 110 and the lower base portion 135 together, as previously discussed.

In an alternative embodiment, the base support 110 and the lower side support 130 can be integrally formed as a single lengthwise structure. In other words, in the alternative embodiment, one of the free ends of the base support 110 can attach directly to the vertical portion 133 of the vertical support 130. The integrally formed base support 110 can couple to the connecting portions 173 of the two stake inserts 170 by fasteners, engagement between a guide rail formed along the single structure and the connecting portions 173, rail and clamping attachments 117, T-slot and T-guide, or other attachment means.

The vertical portion 133 can be permanently fixed to the lower base portion 135 by welding or be detachably fixed using fasteners, clips, detents, pins in slots, catches and locks, or other attachment means. Alternatively, the vertical portion 133 and the base portion 135 can be integrally formed, such as by bending. As shown, the vertical portion 133 is substantially perpendicular to the lower base portion 135 but can be formed at other suitable angles to fit the dimensions of the vehicle 10 and/or user requirements. In an example, the vertical portion 133 is not physically and/or directly connected to the vehicle, such as to the cabin of the vehicle. Where the vertical portion 133 is not directly fixed to the vehicle 10, the vertical portion 133 is supported only by its connection with the lower base portion 135. To increase the joint strength of the vertical and base portions 133, 135, and a joint between the vertical and base portions 133, 135, a gusset plate 137 can be incorporated. The gusset plate 137 can be detachably fixed to both the vertical portion 133 and the lower base portion 135 using fasteners or permanently affixed thereto by welding. The shape and size of the gusset plate 137 along the vertical and base portions 133, 135 can be determined to accommodate a variety of loads experienced by the side support 130. For example, the gusset plate 137 can be selected to increase the stiffness of the side support 130 to increase resistance to wind and load bearing capability of the side support 130. As shown, the gusset plate 137 is triangular with one side attached to the lower base portion 135 and another side attached to the vertical portion 133. One or more holes may be incorporated in the gusset plate 137 to lighten the side support 130 and/or for air flow without sacrificing significant structural rigidity of the side support 130.

The vertical portion 133 can extend from the lower base portion 135 and run along and adjacent an outer rear or top perimeter of the cab 13 to present a sleek and streamline appearance. A clearance, such as a gap, may be provided between the cab 13 and the vertical portion 133 of the two side supports 130 to allow for flexing. In one example, a clearance of one inch is incorporated between the cab 13 and the vertical portion 133 with other clearance or gap contemplated. In some embodiments, intermediate members, such as soft foam or other padding, can be provided between the cab 13 and the side supports 130 to provide protection for the cab 13 and/or the side supports 130.

The side supports 130, such as the length of the vertical portion 133, the length of the lower base portion 135, and/or the length of the upper base portion 139, can be adjusted as appropriate to accommodate different cab 13 and bed 15 dimensions or to suit individual user tastes or requirements. The relative angles or orientations of the components of the side supports 130 can also vary to fit a particular vehicle model or need. The side support 130 can be made from a metal material, such as extruded aluminum, from reinforced composite or plastic material, or from other appropriate rigid materials.

As shown, a secondary or upper base portion 139 extend from a free end of the vertical portion 135 and has a free end 49 extending towards another free end 49 of another upper base portion 139 of the other vertical portion 135. A gap 158 is provided between the two free ends 49 of the two upper base portions 139. The size or dimension of the gap between the two free ends 49 can be selected with an appropriate length horizontal support 150 to match a desired overall width of the modular rail system 100. Alternatively, for a horizontal support 150 with a known or fixed length, the length of the two upper base portions 139 can be selected to match the desired overall width of the modular rail system 100.

As shown, the side support 130 and the base support 110 located on one side of the bed 15 are symmetrical to the side support 130 and the base support 110 on the opposite side of the bed 15. The upper base portion 139 can be permanently affixed to a corresponding vertical portion 133 by welding or being integrally formed, such as by bending. The two components can alternatively be attached together by fasteners, clips, detents, pins in slots, catches and locks, or other attachment means. Each upper base portion 139 is configured for connecting to one or more horizontal supports 150, as further discussed below.

In an example, the horizontal support 150 couples the base supports 110 and the side supports 130 on opposite sides of the vehicle 10 together to form a complete integrated structure. As shown, the horizontal support 150 is coupled to the two upper base portions 139 and the combination extends across and along the upper rear or top perimeter of the cab 13. The horizontal support 150 can be connected to each of the two upper base portions 139 by fasteners, pins engaging in slots, catches and locks, or other attachment means. The two upper base portions 139 can have the same length or different lengths.

In some examples, the upper support portions 139 are omitted and the horizontal support 150 attaches directly to the two vertical portions 133. The horizontal support 150 can comprise a center portion 151 and an engaging portion 153 on opposite ends of the center portion 151. The center portion 151 can be shaped to accommodate features of the vehicle 10, can include attachment means for accessories, or combinations thereof. In one example, the center portion 151 is sized and shaped, such as being contoured, to prevent obstructing both a brake light 11 possibly located at a top center portion of the cab 13 or at a rear window 12 of the cab.

The center portion 151 can include decorative features, such as pictures, designs, and/or words. Padding materials may be added or included to support a load carried in the pickup bed 15, such for leaning surfboard or a plank. In some embodiments, the center portion 151 can incorporate an integrated brake light that can be connected to the vehicle's existing brake light system to serve as an added safety feature. The horizontal support 150 can be adjusted as needed to accommodate different cab 13 and bed 15 dimensions or to suit individual user tastes or requirements. The horizontal support 150 can be made from extruded aluminum, reinforced composite material, or other appropriate rigid material. A gap 158 (FIG. 1A) or mounting plates 156 (FIG. 1B) may also be provided between the engaging portions 153 and the upper base portions 139 to provide mounting points for attachments as will be further discussed below.

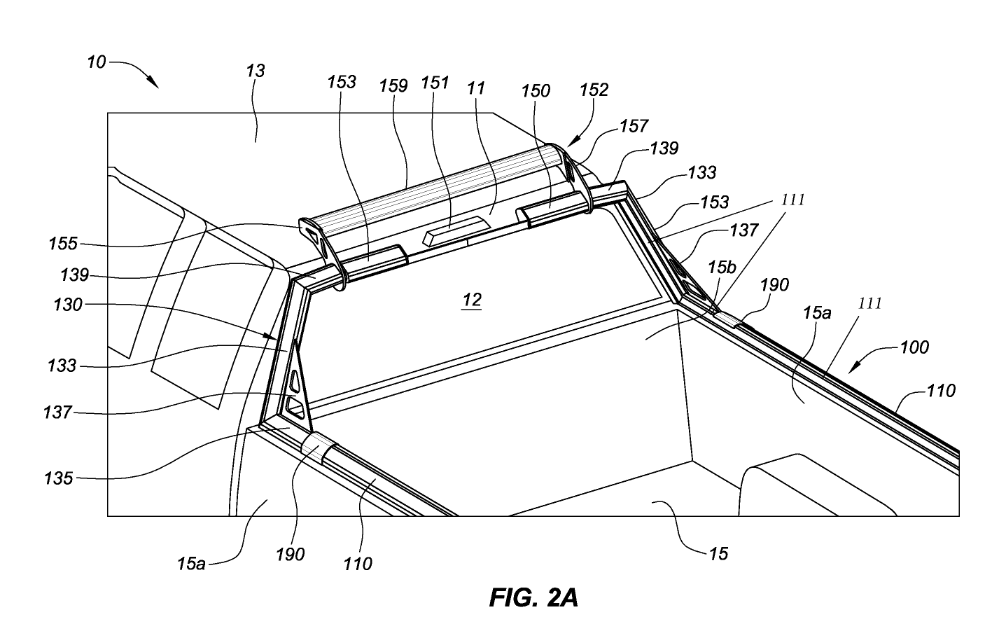

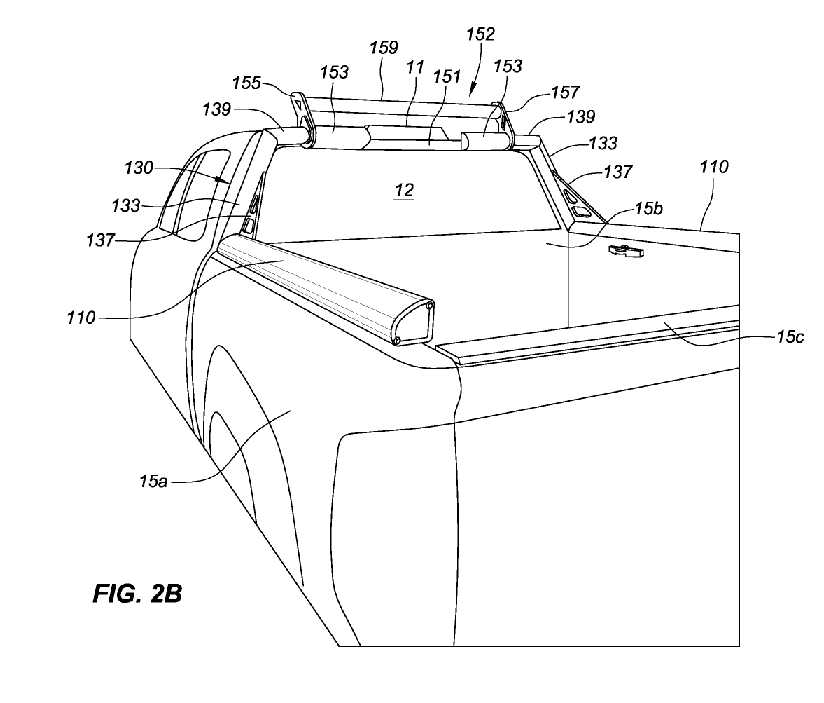

FIGS. 2A and 2B show an embodiment of a modular system 100 of the present disclosure having an attachment extension 152 mounted to the horizontal support 150, which can be used to facilitate the safe transport of items that may be longer than the bed 15 of the vehicle 10. The attachment extension 152 can have a platform 159 extending between a left side bracket 155 and a right side bracket 157, which may instead be called a first bracket 155 and a second bracket 157, respectively. The left side bracket 155 and the right side bracket 157 can attach to the modular system 100 between the upper base portions 139 and on opposite sides of the horizontal support 150. The platform 159 of the attachment extension 152 can be provided as is or can have and over-layer. In an example, extruded elastomer material is wrapped around the platform 159 to provide cushion, support, aesthetic appeal, or for any number of other reasons. In some embodiments, holes, loops, or hooks can extend through the brackets 155, 157 and/or from the brackets to provide securing locations for straps, bungee cords, or other securing mechanisms to secure items resting against the platform 159. Items such as lumber, surfboards, poles, kayaks, or any other large item that may not fit within the pickup bed 15 can be situated such that one end of the item rests in the pickup bed 15 while a bottom portion of the item rests on the platform 159 and part of the item extends upwardly above the cabin 13.

The left side bracket 155 can be a mirror image of the right side bracket 157, the two can be identical but opposite, or the two brackets can be different. The left and right side brackets 155, 157 can attach to the engaging portions 153 of the horizontal support 150 and the upper base portions 139 using fasteners, pins, or other attachment means. In an example, each bracket can incorporate an opening sized and shaped to receive either the engaging portion 153 or the upper base portion 139. The opening can be selected so that the flange does not rotate relative to the engaging portion 153 or the upper base portion 139. In other examples, the brackets 155, 157 can be permanently fixed to the engaging portions 153, such as be welded thereto. Said differently, the attachment extension 152 may be permanently fixed to the horizontal support 150 to form a single unitary piece that is replaceable from the two side supports. In the permanently affixed embodiment, the horizontal support 150 and the attachment extension 152 form a combination that can be attached or disconnected to the two upper base portions 139 as a single piece or as single combination unit. In another embodiment, a gap 158 is provided between the upper base portions 139 and the horizontal support 150 to allow a variety of attachments 152 to slip into the gap 158 and snap into place to removably fix the attachment extension 152 to the modular system 100. In this configuration, a variety of attachments 152 can be quickly swapped without removing the horizontal support 150, such as by using flanges, fasteners, clamps, or combinations thereof. In yet another embodiment, the gap 158 may include specially shaped mounting plates 156 (FIG. 1B) protruding between the upper base portions 139 and the horizontal support 150 to engage variety of accessory items thereto.

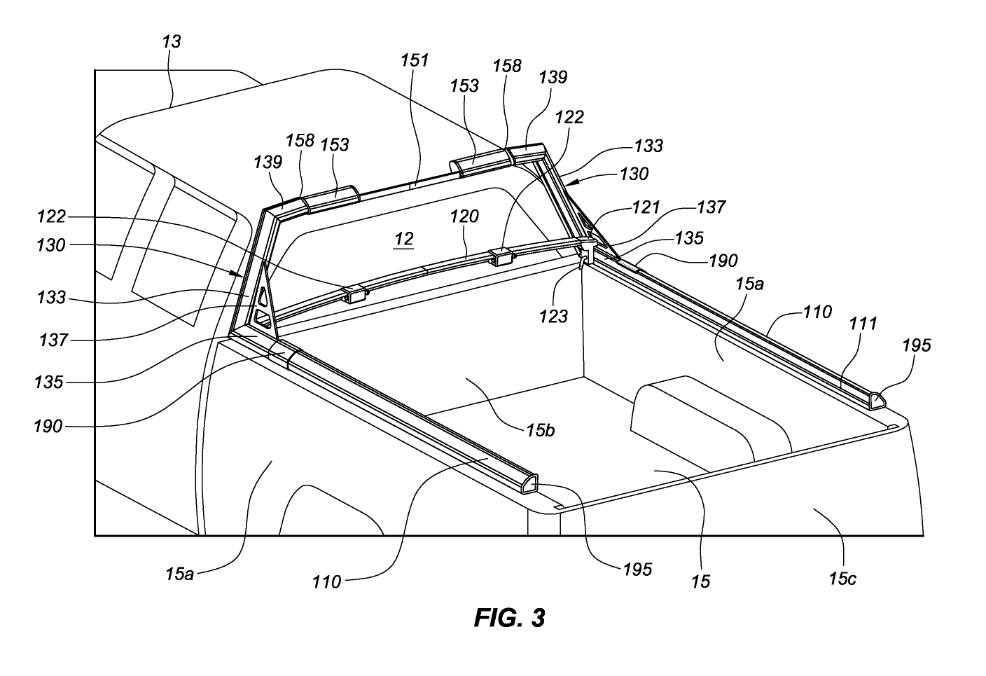

FIG. 3 shows an exemplary modular system 100 with a cross member 120, which is an exemplary accessory item provided in accordance with aspects of the present disclosure. As shown, the cross member 120 is coupled to the two base supports 110 on either side of the pickup bed 15 via track mounts 121. The cross member 120 can have one or more mounts 122 along the length of the cross member to secure items to the mounts 122. The cross member 120 can function as a detachable bicycle rack cross bar with bicycle fork attachment mounts as the mounts 122 shown. The mounts 122 can each have a pin extending from opposite side flanges of the mount 122 for engaging a front fork of a bicycle, which can be a road bike, a mountain bike, a race bike, or other bicycle types.

The track mounts 121 can be provided on opposite ends of the cross member 120 to engage and slide in a track 111 provided on or with the two base supports 110. The cross member 120 can attach to the two track mounts 121 through various means, including by fasteners, flanges, straps, interference fit, detents, or other known methods and/or means. The two tracks 111 can face inward with respect to the side walls 15b of the pickup bed 15 and can extend part or the entire length of the two base supports. The track mounts 121 can have a protrusion received in the track 111, such as a T-guide in a T-slot. Installation and removal of the track mount 121 to the track 111 can be done with a locking feature 123, such as a tensioning lever, knob, set screw, or other shaped device that fixes the track mount 121 at a desired position along the track 111. The two spaced apart tracks 111 may also be formed in each corresponding lower base portions 135, which are aligned with the tracks of the base support 110 that the two lower base portions 135 attach to.

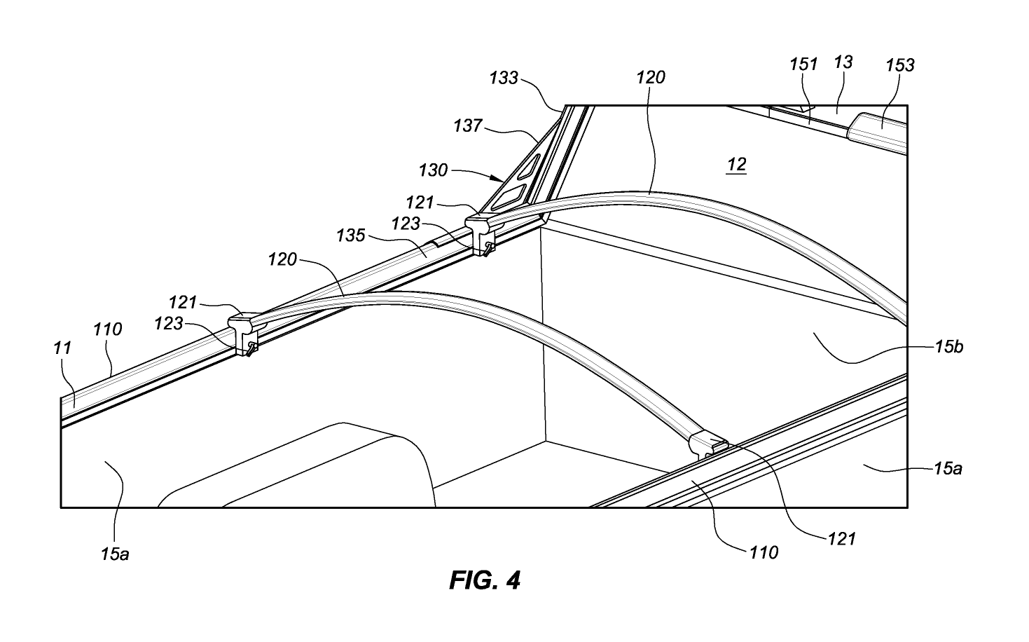

FIG. 4 shows an exemplary embodiment of a modular system 100 shown with a plurality of cross members 120 coupled to the base supports 110. The cross members 120 can each be a spanning bar having track mounts 121 at opposite ends of the spanning bar coupled to the base supports 110. Using two or more cross members 120 can allow the modular system 100 to operate or function as a cover system. As discussed above, the track mounts 121 can engage and slide in a track 111 defined in a surface of each base support 110. The spanning bars can arc or bow inwardly or outwardly as shown in FIG. 4, or they can be generally straight. In some embodiments, the spanning bars 124 can have a combination of straight and arc sections. The spanning bars 124 can be monolithic or constructed from a plurality of components. The spanning bars 124 can be used to support a flexible or solid cover (not shown) placed over the area of the pickup bed 15. The cover can be in the form of a monolithic, segmented, or paneled construction. Installation and removal of the spanning bars can be accomplished with a locking feature 123, such as a tensioning lever, knob or other shaped device that can clamp, that secures a track mount 121 at each end of each spanning bar to the base supports 110, as previously discussed.

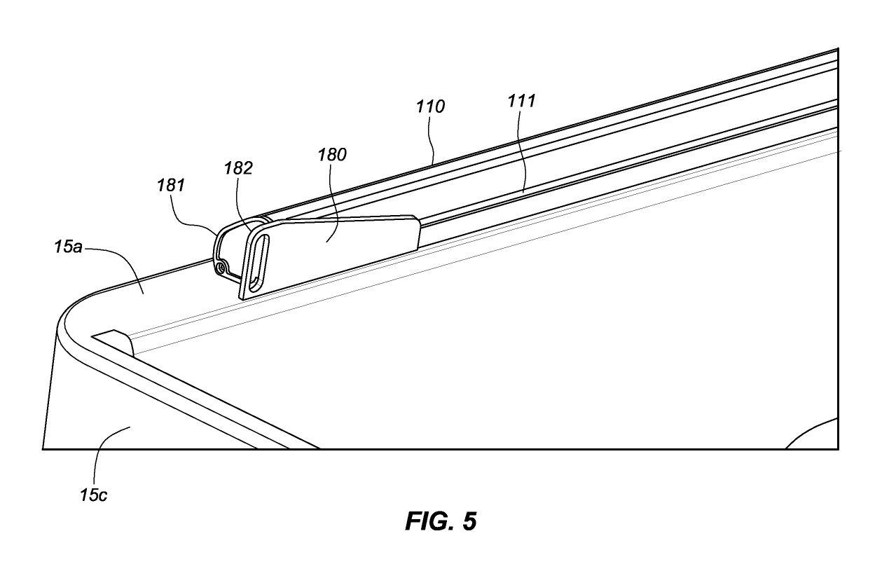

FIG. 5 shows an exemplary embodiment of a modular system 100 with a handle 180 at a rear end of the base support 110, which can provide a safe and stable grip 181 for a user to grip or hold on to while pulling himself up to enter or access the bed of a vehicle. A cutout 182 can be provided in the handle 180 for the user to place one or more fingers through the cutout to enhance a user's grip. The cutout 182 can form a closed loop grip 181 as shown or an open loop with a sufficiently large gap to not cause pinching to the one or more fingers. In one example, the cutout 182 can form a U-shaped grip. The cutout 182 can also include ridges to aid the user's grip. Edges around the cutout 182 may be smoothed to remove sharp corners to provide additional comfort and safety to the user. The cutout 182 may also provide a securing location for straps, bungee cords, or other securing mechanisms to extend over and secure items. Loops, hooks, or extensions may also be provided around the grip 181.

The handle 180 can be removably or permanently coupled to any of the base supports 110. For example, the handle 180 can be slidably received in the track 111, fastened, welded, fused, or integrally formed with one of the base supports 110. The handle 180 may also be coupled to one of the base support 110 using a clamping system that can include use of a lever clamp, knobs, bolts and nuts, or other means. The handle 180 can also be attached to the inward facing surface, the top surface, and/or the outward facing surface of the base support 110. In some embodiments, a plurality of handles 180 can be coupled to each of the base supports 110 and different or the same numbers of handles can be attached to each of the two base supports 110.

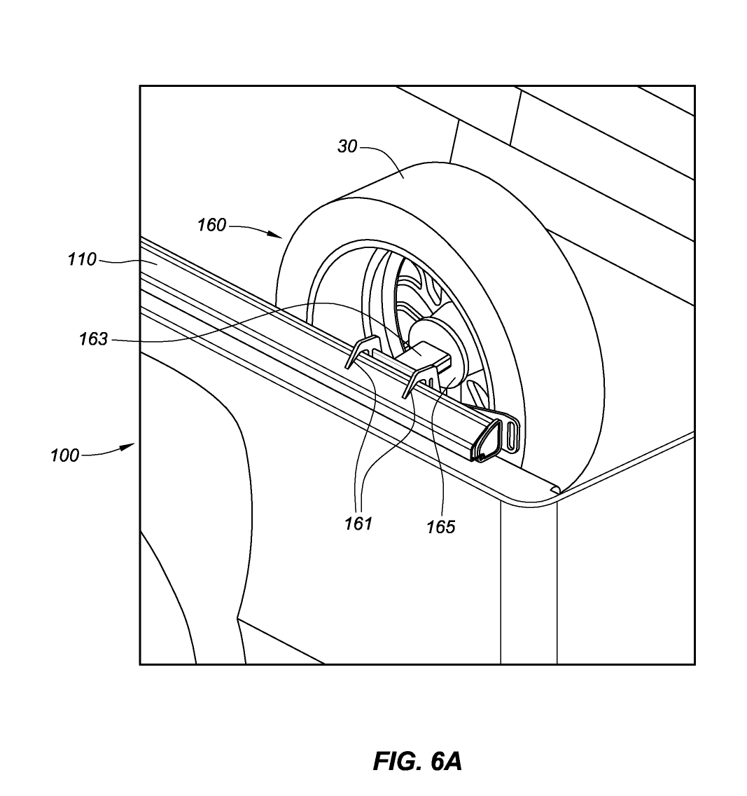

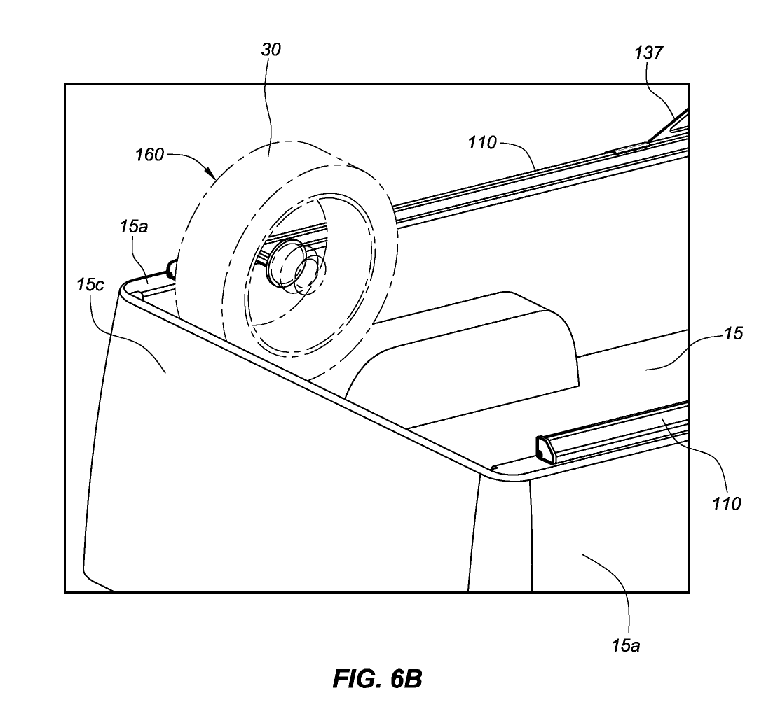

FIGS. 6A and 6B illustrate an exemplary embodiment of a modular system 100 with a spare tire 30 mounted to a spare tire mount 160. The spare tire mount 160 can be coupled to one of the base supports 110 at various locations along the base support 110. As shown in the exemplary embodiment, the spare tire mount 160 can be coupled to the base support 110 along an inward facing surface of the base support 110 although an upward or outward facing surface of the base support 110 can alternatively be selected as a location for coupling the spare tire mount.

The spare tire mount 160 can comprise a tire support flange 165 coupled to a pair of support hooks 165 by an intermediate extension member 163. The spare tire mount 160 can include locking mechanisms to secure and prevent theft of the spare tire 30. In some embodiments, the spare tire mount 160 can provide a means for preventing the spare tire 30 from rotation, such as a pin in a hole, a hook, a strap, or a bracket for preventing tire rotation. The two support hooks 165 can hook over the base support 110 to suspend and secure the tire 30 to the base support 110. The support hooks 165 can reach over a top surface of the base support 110 to grip against an opposite surface of the base support 110. The spare support mount 160 can be secured to the base support 110 by a locking system that can include use of a lever clamp, knobs, bolts and nuts, or other means to prevent the spare tire 30 and tire mount 160 from unintended movement or release. The support mount 160 may also engage and slide in a track 111 of any of the two base supports 110 and be positioned anywhere along the length of the track. The engagement can be by way of a T-slot and a T-guide.

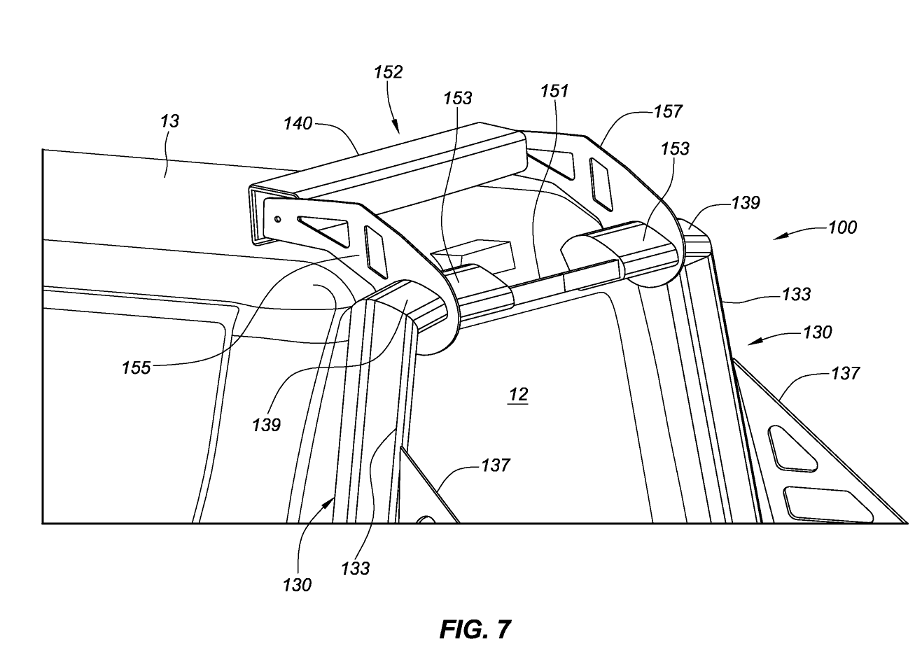

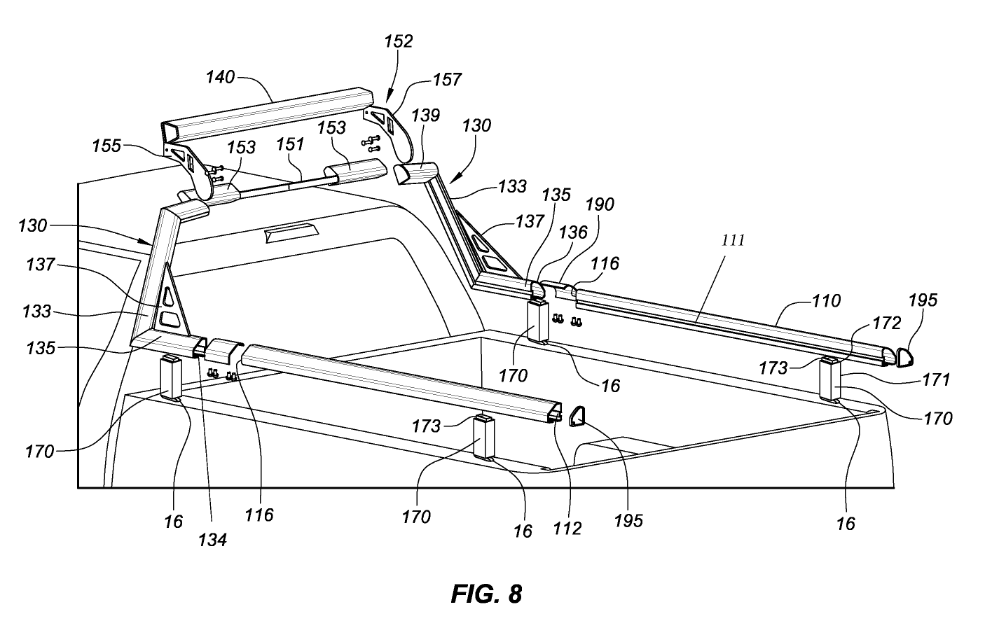

FIGS. 7 and 8 show an exemplary embodiment of a modular system 100 similar to the embodiment of FIGS. 2A and 2B except that the platform 159 of the attachment extension 152 can incorporate lighting elements, a light bar, or a light strip 140. Thus, an aspect of the present disclosure include a modular track system comprising a platform 159 that can be removed and replaced with any other structure or device and be attached to the brackets 155, 157 and/or the horizontal support 150, such as the light bar 140 of the present embodiment. In another embodiment, the entire attachment extension 152, including the platform 159, can be replaced with a different attachment extension 152 having a different accessory attached thereto, such as a light bar 140. The light bar 140 can be pivotably coupled between the left side bracket 155 and the right side bracket 157, which can slip into a gap 158 and snap into place or tied to the attachment plates 156 to attach the attachment 152 to the modular system 100.

The light bar 140 can be an LED light strip having directional LEDs, having conventional LEDs, incandescent, halogen, or other types of lights connected to a bar and located in a housing. An optional transparent cover can attach to the housing to protect internal lighting elements inside the housing. The light bar 140, such as the housing, can be pivotably mounted to the left and right side brackets 155, 157 to direct light in any desired direction, such as to a front of the vehicle 10, pointing horizontally, downwardly, or upwardly, or at the bed 15 of the vehicle 10 or somewhere to the general vicinity of the bed 15. In various embodiments, individual lights can also be coupled to the one or more upper base portions 139, the engaging portions 153, and/or the attachment extension 152. Power for the light bar 140 can be provided using appropriate electrical coupling of a power source, such as to one or more dedicated batteries and/or generators or attach to the vehicle's power system using the car battery and/or engine for power. Switches and/or dimmers can be electrically coupled to the light bar 140 to provide control of the lighting and can be located on or near the light bar 140 at a central location such as a control panel, or in other appropriate locations. Exemplary lighting elements and powering configurations for the lighting elements are further discussed in co-pending application Ser. No. 14/835,956, filed Aug. 26, 2015, the contents of which are expressly incorporated herein by reference for all purposes. The various lighting elements described in the co-pending application may be used with the housing of the light bar 140 described herein and be powered using the various options described in the co-pending application.

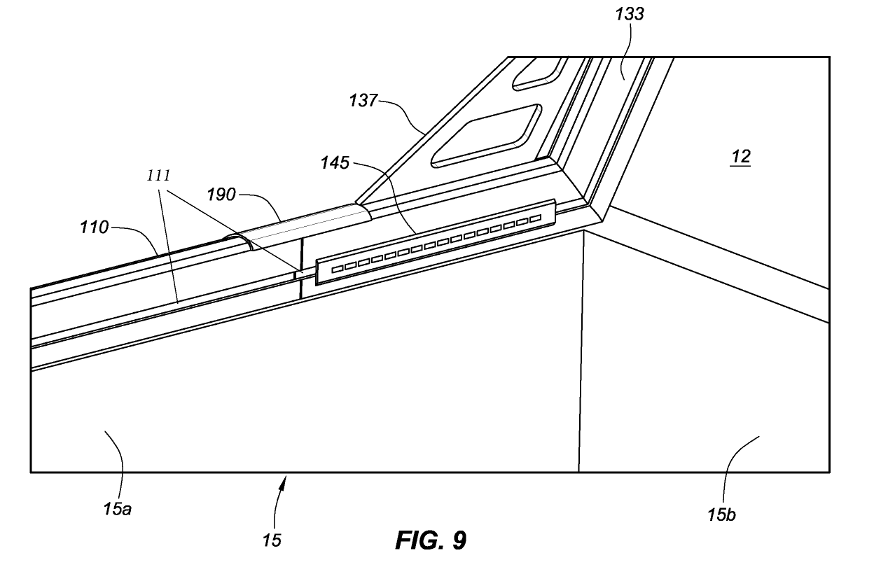

FIG. 9 shows an exemplary embodiment of a modular system 100 with a light strip 145 mounted to one of the base supports 110. In other examples, more than one light strip 145 may be mounted to each base support 110 and both base supports 110 may have one or more light strips 145 attached thereto. The light strip 145 shown may be attached to the track 111 on the base support 110 through means described elsewhere herein. However, the location of the light strip 145 is not limited and can be mounted at various other locations along the base supports 110, the side supports 130, the horizontal support 150, on the attachment extension 152, and/or on upper cross members 120. These locations can include inward facing, outward facing, upward facing, downward facing, and angled orientations as desired by individual users. The light strip 145 can be attached to the modular system 100 using bolts, adhesives, detents, snap into place, or other attachment means, such as using a T-slot with a T-guide. The light strip 145 can be any shape, size, and power, and can include LEDs, incandescent, halogen, or other light sources as appropriate, such as those disclosed in co-pending application Ser. No. 14/835,956, previously incorporated herein by reference. Power for the light strips 145 and light bars can be provided using appropriate electrical coupling of a power source, such as to one or more dedicated batteries and/or generators or attached to the vehicle's power system, to a solar energy source, to a car battery, and/or to the engine for power. Switches and/or dimmers can be electrically coupled to each light strip 145 to provide control of the lighting and can be located on or near each light strip 145 at a central location, such as a control panel, or in other appropriate locations.

Although limited embodiments of modular rack systems and assemblies and their components and accessories have been specifically described and illustrated herein, many modifications and variations will be apparent to those skilled in the art. For example, the various support devices may incorporate custom paint, have different outer contoured shapes, provided with metallic overcoats, multiple finishes including anodizing and powder coating and wet paint, etc. Furthermore, it is understood and contemplated that features specifically discussed for one support device embodiment may be adopted for inclusion with another support device embodiment, provided the functions are compatible. Accordingly, it is to be understood that the support devices and assemblies and their components constructed according to principles of the disclosed device, system, and method may be embodied other than as specifically described herein. The disclosure is also defined in the following claims.

What is claimed is:

1. A modular system for mounting on a vehicle, the modular system comprising a multi-component support structure and an attachment removably coupled to the support structure, the support structure having a width and a length and comprising:
two side supports, each side support comprising a vertical portion, a lower base portion extending from the vertical portion, and a gusset plate interconnecting the vertical portion with the lower base portion;
two base supports respectively removably coupled to the lower base portions;
a horizontal support removably attached to the two side supports; and
wherein the horizontal support or the two base supports are interchangeable with a second horizontal support or a second set of two base supports to produce a support structure having a different width, a different length, or both a different width and a different length.

2. The modular system of claim 1, further comprising an attachment device configured to clamp the support structure to a vehicle.

3. The modular system of claim 1, further comprising a plurality of stake inserts, each stake insert comprising an anchor portion configured to be received in a stake pocket of a vehicle, a connecting portion configured to engage a surface of the base support or side support, and a mounting plate configured to restrict the depth of the anchor portion in a stake pocket.

4. The modular system of claim 3, wherein the anchor portion is a long rectangular block having a size substantially equal to or slightly less than a size of a stake pocket.

5. The modular system of claim 1, wherein both the horizontal support and the second set of two base supports are interchangeable to produce both a different width and a different length.

6. The modular system of claim 1, further comprising a T-slot on a side of at least one of the base supports.

7. The modular system of claim 1, wherein the attachment has a left side bracket, a right side bracket, and a module coupled between the left side bracket and the right side bracket.

8. The modular system of claim 7, wherein the module is a platform configured to support a surface bearing against the platform.

9. The modular system of claim 8, wherein loops or hooks extend outwardly from the left and right side brackets to provide securing locations for a securing mechanism to extend over and secure the surface against the platform.

10. The modular system of claim 7, wherein the module is a light bar pivotably coupled to the left side bracket and the right side bracket.

11. The modular system of claim 1, wherein the attachment is one or more cross members extending between the two base supports that are slidably fixed along tracks defined in a surface of each of the two base supports.

12. The modular system of claim 11, wherein a track mount is provided on each of two opposite ends of each cross member to engage and slide along the tracks of the base supports.

13. The modular system of claim 12, wherein a locking feature is provided with each track mount to lock the track mount at a desired location.

14. The modular system of claim 12, wherein one or more accessory mounts are fixed along the cross member.

15. The modular system of claim 1, wherein the attachment is a tire mount coupled to a bar support.

16. The modular system of claim 15, wherein the tire mount comprises a tire support flange coupled to a pair of support hooks by an intermediate extension member, and a locking mechanism to prevent the tire mount from unintended movement or release.

17. The modular system of claim 1, wherein a handle is coupled to one of the base supports and to provide a gripping surface for a user to provide access to a vehicle.

18. The modular system of claim 1, wherein a light strip is coupled directly to the multi-component support structure.

19. The modular system of claim 7, wherein the left side bracket and the right side bracket are coupled to the horizontal support.

20. A method of manufacturing a modular system for a vehicle, the method comprising:
providing two side supports, each side support comprising a vertical portion, a lower base portion extending from the vertical portion, and a gusset plate interconnecting the vertical portion with the base portion;
coupling two base supports to corresponding lower base portions of the two side supports;
removably coupling a horizontal support between the two side supports;
the two side supports, the two base supports, and the horizontal support forming a multi-component support structure having a length and a width;
removable coupling an attachment to the support structure; and
providing removable connections at the two side supports for replacing the horizontal support with a second horizontal support, for replacing the two base supports with a second set of two base supports, or to replace both the horizontal support with a second horizontal support and the two base supports with a second set of two base supports.

21. The method of claim 19, wherein the attachment is at least one of a cross member extending between the base supports, a tire mount coupled to one base support, a light strip coupled directly to the support structure, a light bar coupled to the horizontal support, and a platform coupled to the horizontal support.
